(19) United States
(12) Patent Application Publication
(10) Pub. No.: US 2024/0351875 A1
(43) Pub. Date: Oct. 24, 2024

(54) REFORMING UNITS FOR HYDROGEN PRODUCTION

(71) Applicant: GOLU HYDROGEN TECHNOLOGIES INC., Edmonton (CA)

(72) Inventors: Inder Pal SINGH, Edmonton (CA); Shradha SINGH, Edmonton (CA); Mykola KONDRATENKO, Edmonton (CA); Syed Sameen ZAIDI, Edmonton (CA); Bharatkumar Babubhai MISTRY, Edmonton (CA); Zhiyong LI, Edmonton (CA); Carson James BERRY, Sherwood Park (CA)

(21) Appl. No.: 18/684,794

(22) PCT Filed: Aug. 30, 2022
(86) PCT No.: PCT/CA2022/051308

§ 371 Date: Feb. 19, 2024

Related U.S. Application Data
(60) Provisional application No. 63/239,462, filed on Sep. 1, 2021.

(51) Int. Cl. C01B 3/38; B01J 12/00; B01J 19/00; B01J 19/24; C01B 3/14; C01B 3/32; C01B 3/56; H01M 8/0612; H01M 8/0662

(52) U.S. Cl. CPC C01B 3/384; B01J 12/007; B01J 19/0013; B01J 19/2425; C01B 3/14; C01B 3/323; C01B 3/56; H01M 8/0618; H01M 8/0687; B01J 2219/00103; B01J 2219/00157; C01B 2203/0233; C01B 2203/0283; C01B 2203/042; C01B 2203/047; C01B 2203/0475; C01B 2203/0811; C01B 2203/0883; C01B 2203/1229; C01B 2203/84

(57) ABSTRACT

There is described a reforming unit for hydrogen production and a power generation device incorporating at least the reforming unit for generating electricity. The reforming unit generally has a catalytic burner defining a burner cavity; a reaction assembly within the burner cavity and in thermal communication therewith, the reaction assembly including; a reactor conduit extending annularly around an axis and axially between an input port and an output port, the input port being fluidly coupled to a wet fuel source supplying wet fuel, the reactor conduit having distributed therein a plurality of catalyst elements; and a syngas conduit extending along the axis, within the reactor conduit and in thermal communication therewith, the syngas conduit having an input port fluidly coupled to the output port of the reactor conduit, and an output port; the catalytic burner having a plurality of heating devices surrounding the burner cavity.

### FIELD

The improvements generally relate to hydrogen production and more particularly relate to hydrogen production involving steam reforming.

### BACKGROUND

Hydrogen can be regarded as one of the key energy solutions for the future, not only because of its energy density, but also because its use does not generate undesirable waste. One hydrogen production process involves steam reforming in which high-temperature steam is used to produce hydrogen from a fuel such as methane, ethanol and the like. In a typical steam reforming process, the fuel reacts with high-pressure steam in the presence of a catalyst to produce synthesis gas, or “syngas,” i.e., a mixture including hydrogen, carbon monoxide, and a relatively small amount of carbon dioxide. As steam reforming is endothermic in that heat must be supplied to the process for the reaction to proceed, the production process generally involves the use of a reforming unit which can guide and sustain the interaction of the high-pressure steam to the fuel in the presence of the catalyst and allow an outgoing flow of syngas. Although existing reforming units are satisfactory to a certain degree, there always remains room for improvement.

### SUMMARY

It was found that there was a need in the industry to increase the efficiently at which the heat required in the endothermic reforming reaction can be provided.

In accordance with a first aspect of the present disclosure, there is provided a reforming unit for hydrogen production, the reforming unit comprising: a catalytic burner defining a burner cavity; a reaction assembly within the burner cavity and in thermal communication therewith, the reaction assembly including: a reactor conduit extending annularly around an axis and axially between an input port and an output port, the input port being fluidly coupled to a wet fuel source supplying wet fuel, the reactor conduit having distributed therein a plurality of catalyst elements; and a syngas conduit extending along the axis, within the reactor conduit and in thermal communication therewith, the syngas conduit having an input port fluidly coupled to the output port of the reactor conduit, and an output port; the catalytic burner having a plurality of heating devices surrounding the burner cavity, wherein, upon activation, the heating devices heating the burner cavity, the reactor conduit and the wet fuel thereby feeding, in cooperation with the reaction catalyst elements, an endothermic reforming reaction producing a hydrogen containing syngas outputted at the output of the syngas conduit. In some embodiments, the heating devices can be advantageously used to heat the burner cavity in an efficient manner compared to existing reforming units only having a bottom, axially oriented heating device. For instance, the multi-heating devices can facilitate a fast heating of the catalytic burner, provide a uniform heating of the catalytic burner, maintain an even reaction temperature from a bottom to a top of the burner cavity and/or prevent hot spot within the burner cavity which can therefore limit the formation of NOx.

Further in accordance with the first aspect of the present disclosure, at least two of the heating devices can for example be axially spaced apart from one another.

Still further in accordance with the first aspect of the present disclosure, at least two of the heating devices can for example be circumferentially spaced apart from one another around the catalytic burner.

Still further in accordance with the first aspect of the present disclosure, the reaction assembly can for example be a first reaction assembly, the reforming unit further comprising a second reaction assembly laterally spaced apart from the first reaction assembly within the burner cavity.

Still further in accordance with the first aspect of the present disclosure, the input ports of the reactor conduits can for example be coupled to the wet fuel source via a first valve system actionable to controllably receive a flow of wet fuel at the input ports of the reactor conduits.

Still further in accordance with the first aspect of the present disclosure, the heating devices can for example be burner devices collectively coupled to an air source and to a fuel source via a second valve system actionable to controllably receive a flow of air and fuel for burning thereof.

Still further in accordance with the first aspect of the present disclosure, the wet fuel source can for example have a water source and a fuel source fluidly coupled to the input port of the reactor conduit via the first valve system.

Still further in accordance with the first aspect of the present disclosure, the catalyst elements can for example be provided in the form of a stack of annular metal discs coated with reforming catalysts, the annular metal discs receiving the syngas conduit therein.

Still further in accordance with the first aspect of the present disclosure, the reforming catalysts can for example be substantially free of Cobalt (Co), Ruthenium (Ru), Rhodium (Rh), Palladium (Pd), Platinum (Pt), Iron (Fe), Molybdenum (Mb), and Boron (B).

Still further in accordance with the first aspect of the present disclosure, the catalytic burner can for example have a fume port fluidly connected to a fume conduit carrying combustion fumes away from the catalytic burner.

Still further in accordance with the first aspect of the present disclosure, the reforming unit can for example further comprise a heat exchanging unit being in thermal exchange contact between the fume conduit and a fuel conduit incoming from the wet fuel source.

Still further in accordance with the first aspect of the present disclosure, the reforming unit can for example further comprise a heat exchanger unit being in thermal exchange contact between the syngas conduit and a fuel conduit incoming from the wet fuel source.

Still further in accordance with the first aspect of the present disclosure, the reforming unit can for example further comprise a first heat exchanging unit positioned downstream from a water source and in thermal exchange contact between a water conduit fluidly coupled to the water source and the syngas conduit to heat the water incoming from the water source with the syngas exiting the reforming unit.

Still further in accordance with the first aspect of the present disclosure, the reforming unit can for example further comprise a second heat exchanging unit positioned downstream from the water source and in thermal exchange contact between a water conduit fluidly coupled to the water source and a fume conduit to heat the water incoming from the water source with combustion fumes exiting the fume conduit.

Still further in accordance with the first aspect of the present disclosure, the first and second heat exchanging units can for example be provided along the same water conduit, with the second heat exchanging unit being downstream from the first heat exchanging unit.

Still further in accordance with the first aspect of the present disclosure, the reforming unit can for example further comprise a third heat exchanging unit positioned downstream from a first fuel source and in thermal exchange contact between a first fuel conduit fluidly coupled to the first fuel source and the syngas conduit to heat fuel incoming from the first fuel source with the syngas exiting the reforming unit.

Still further in accordance with the first aspect of the present disclosure, the reforming unit can for example further comprise a third heat exchanging unit positioned downstream from the first fuel source and in thermal exchange contact between a fuel conduit fluidly coupled to the first fuel source and the fume conduit to heat the fuel incoming from the first fuel source with the combustion fumes exiting the fume conduit.

Still further in accordance with the first aspect of the present disclosure, the third and fourth heat exchanging units can for example be provided along the same fuel conduit, with the fourth heat exchanging unit being downstream from the third heat exchanging unit.

Still further in accordance with the first aspect of the present disclosure, the wet fuel is wet ethanol.

In accordance with a second aspect of the present disclosure, there is provided a reforming unit for hydrogen production, the reforming unit comprising: a catalytic burner defining a burner cavity and having a burner device burning an ignition mixture, heating the burner cavity and generating combustion fumes exiting the burner cavity via a fume conduit; a reaction assembly within the burner cavity and in thermal communication therewith, the reaction assembly including: a reactor conduit extending annularly around an axis and axially between an input port and an output port, the input port being fluidly coupled to a wet fuel source supplying a wet fuel, the reactor conduit having distributed therein a plurality of reaction catalyst elements; and a syngas conduit extending along the axis, within the reactor conduit and in thermal communication therewith, the syngas conduit having an input port fluidly coupled to the output port of the reactor conduit, and an output port; and at least one of a first heat exchanging unit being in thermal exchange contact between the fume conduit and the wet fuel source, and a second heat exchanging unit being in thermal exchange contact between the syngas conduit and the wet fuel source; wherein, upon activation, the heating device heating the burner cavity, the reactor conduit and the wet fuel thereby feeding, in cooperation with the reaction catalyst elements, an endothermic reforming reaction producing a hydrogen containing syngas outputted at the output of the syngas conduit, with at least one of the outputted syngas and the combustion fumes heating back a corresponding one of the incoming wet fuel and the incoming ignition mixture.

Further in accordance with the second aspect of the present disclosure, the first heat exchanging unit can for example be positioned downstream from a water source and in thermal exchange contact between a water conduit fluidly coupled to the water source and the syngas conduit to heat the water incoming from the water source with the syngas exiting the reforming unit.

Still further in accordance with the second aspect of the present disclosure, the second heat exchanging unit can for example be positioned downstream from the water source and in thermal exchange contact between a water conduit fluidly coupled to the water source and a fume conduit to heat the water incoming from the water source with combustion fumes exiting the fume conduit.

Still further in accordance with the second aspect of the present disclosure, the first and second heat exchanging units can for example be provided along the same water conduit, with the second heat exchanging unit being downstream from the first heat exchanging unit.

Still further in accordance with the second aspect of the present disclosure, the reforming unit can for example further comprise a third heat exchanging unit positioned downstream from a first fuel source and in thermal exchange contact between a first fuel conduit fluidly coupled to the first fuel source and the syngas conduit to heat fuel incoming from the first fuel source with the syngas exiting the reforming unit.

Still further in accordance with the second aspect of the present disclosure, the reforming unit can for example further comprise a third heat exchanging unit positioned downstream from the first fuel source and in thermal exchange contact between a fuel conduit fluidly coupled to the first fuel source and the fume conduit to heat the fuel incoming from the first fuel source with the combustion fumes exiting the fume conduit.

Still further in accordance with the second aspect of the present disclosure, the third and fourth heat exchanging units can for example be provided along the same fuel conduit, with the fourth heat exchanging unit being downstream from the third heat exchanging unit.

Still further in accordance with the second aspect of the present disclosure, the catalytic burner can for example have a plurality of heating devices surrounding the burner cavity.

In accordance with a third aspect of the present disclosure, there is provided a reforming unit comprising: a catalytic burner defining a burner cavity; a reaction assembly within the burner cavity and in thermal communication therewith, the reaction assembly including: a reactor conduit extending annularly around an axis and axially between an input port and an output port, the input port being fluidly coupled to an input fuel source supplying input fuel, the reactor conduit having distributed therein a plurality of catalyst elements; and an output gas conduit extending along the axis, within the reactor conduit and in thermal communication therewith, the output gas conduit having an input port fluidly coupled to the output port of the reactor conduit, and an output port; the catalytic burner having a plurality of heating devices surrounding the burner cavity.

In accordance with a fourth aspect of the present disclosure, there is provided an integrated hydrogen production system incorporating one or more of the reforming units disclosed herein.

In accordance with a fifth aspect of the present disclosure, there is provided a power generation device incorporating one or more of the reforming units disclosed herein.

Further in accordance with the fifth aspect of the present disclosure, the power generation device can for example further comprise a fuel cell receiving the hydrogen gas stream and an air stream, and generating electricity.

Many further features and combinations thereof concerning the present improvements will appear to those skilled in the art following a reading of the instant disclosure.

### DESCRIPTION OF THE FIGURES

FIG. 1 is a side and sectional view showing an example of a reforming unit for hydrogen production, showing a catalytic burner enclosing reactor assemblies each having a reactor conduit and a syngas conduit, in accordance with one or more embodiments; wherein FIG. 1A is a sectional view of the reforming unit of FIG. 1, taken along section 1A-1A of FIG. 1, showing the reactor assemblies, in accordance with one or more embodiments; and wherein FIG. 1B is a sectional view of the reforming unit of FIG. 1, taken along section 1B-1B of FIG. 1, showing outputs of the syngas conduits, in accordance with one or more embodiments.

FIG. 2 is a view showing an alternate example of a catalyst unit enclosed in the reactor conduit of FIG. 1, in accordance with one or more embodiments.

FIG. 3 is a schematic view of another example of a reforming unit, showing heat exchangers, in accordance with one or more embodiments.

FIG. 4 is a block diagram of an example of a power generation system including the reforming unit of FIG. 3, in accordance with one or more embodiments.

FIG. 5 is a schematic view of the power generation system of FIG. 4, in accordance with one or more embodiments.

FIG. 6 is a block diagram of another example of a power generation system, in accordance with one or more embodiments.

### DETAILED DESCRIPTION

It is provided a reforming unit for hydrogen production, the reforming unit comprising a catalytic burner defining a burner cavity; a reaction assembly within the burner cavity and in thermal communication therewith, the reaction assembly including a reactor conduit extending annularly around an axis and axially between an input port and an output port, the input port being fluidly coupled to a wet fuel source supplying wet fuel, the reactor conduit having distributed therein a plurality of catalyst elements; and a syngas conduit extending along the axis, within the reactor conduit and in thermal communication therewith, the syngas conduit having an input port fluidly coupled to the output port of the reactor conduit, and an output port; the catalytic burner having a plurality of heating devices surrounding the burner cavity, wherein, upon activation, the heating devices heating the burner cavity, the reactor conduit and the wet fuel thereby feeding, in cooperation with the reaction catalyst elements, an endothermic reforming reaction producing a hydrogen containing syngas outputted at the output of the syngas conduit.

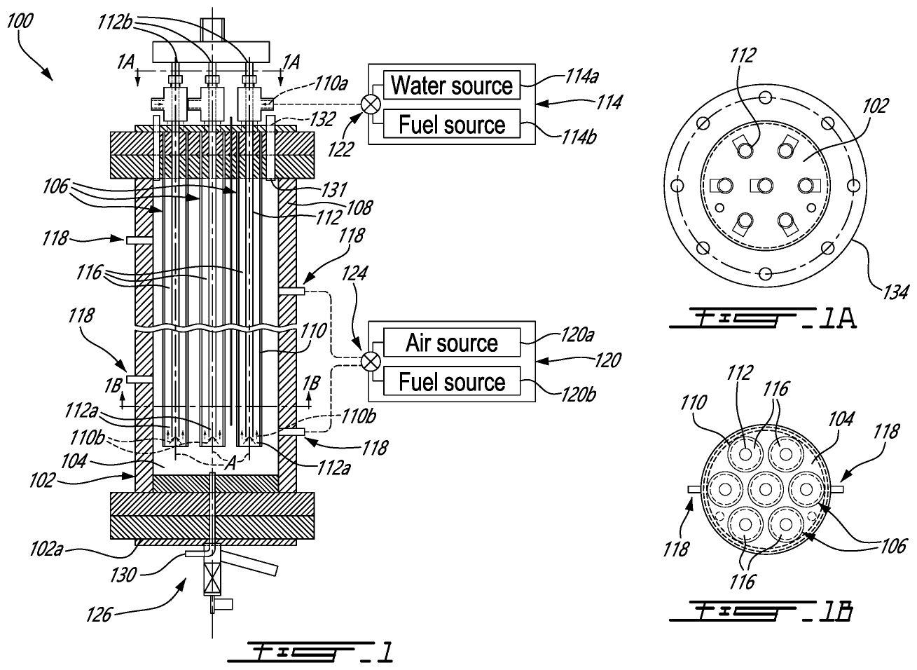

As provided herein, FIG. 1 shows an example of a reforming unit 100 for hydrogen production, in accordance with an embodiment. As depicted, the reforming unit 100 has a catalytic burner 102 defining a burner cavity 104 and a number of reaction assemblies 106. The catalytic burner 104 can be provided with an insulating layer 108 surrounding the burner cavity 104 for insulating purposes. In this example, seven reaction assemblies 106 are shown, but it is intended that the reforming unit 100 can have fewer than seven reaction assemblies or more than seven reaction assemblies in some other embodiments. As shown, the reaction assemblies 106 may be preferably laterally spaced apart from one another in the burner cavity 104.

As illustrated, the reaction assemblies 106 are within the burner cavity 104 and in thermal communication with the burner cavity 104. Each reaction assembly 106 has a reactor conduit 110 and a corresponding syngas conduit 112. As shown, the reactor conduit 110 extends annularly around an axis A and axially between an input port 110a and an output port 110b. The input port 110a of the reactor conduit 110 is fluidly coupled to a wet fuel source 114 supplying wet fuel at a fixed or variable flow rate to the reactor conduit 110. The reactor conduit 110 has distributed therein reaction catalyst elements 116, examples of which are provided further below. The syngas conduit 112 extends along the axis A of the corresponding reaction assembly 106, lies partially or wholly within the reactor conduit 104 and is in thermal communication with the corresponding reactor conduit 110. As shown, the syngas conduit 112 has an input port 112a which is fluidly coupled to the output port 110b of the reactor conduit 110, and an output port 112b.

As shown, the catalytic burner 102 has heating devices 118 surrounding the burner cavity 104. In some embodiments, the heating devices 118 are ignition devices fluidly coupled to an ignition mixture source 120 supplying air and fuel, for instance. The ignition devices may be radially extending with a burner port inwardly oriented with respect to the burner cavity 104. In some other embodiments, the heating devices 118 can be electrical heaters. As shown in the embodiment of FIG. 1, some of the heating devices 118 are axially spaced from one another around the burner cavity 104, and some of the heating devices 118 are circumferentially spaced from one another around the burner cavity 104. Upon activation, the heating devices 118 collectively heat the burner cavity 104, the reactor conduits 110 and the wet fuel which can in turn feed, in cooperation with the reaction catalyst elements 116, an endothermic reforming reaction producing a hydrogen containing syngas outputted at the output 112b of the syngas conduit 112. The steam reforming reaction can be conducted at a pressure up to about 1000 psi in some embodiments. It was found that the heating devices 118 surrounding the burner cavity 104 can be used to heat it in an advantageous and efficient manner compared to existing reforming units only having a bottom, axially oriented heating device.

In this embodiment, the fuel is provided in the form of ethanol as it was found that wet ethanol can be advantageously used in conjunction of the reforming unit 100 for the production of hydrogen. For instance, wet ethanol can be less cost intensive to produce compared to anhydrous ethanol which is used for auto-thermal processes. However, in some other embodiments, other types of fuel can be used including, but not limited to, methane, natural gas, bioethanol, alcohols, or any other suitable hydrogen-containing fuel, to name a few examples. The fuel can originate from a non-renewable fuel or from a renewable source, depending on the embodiment.

In one embodiment, the fuel is wet ethanol and the endothermic reforming reaction is as follows:

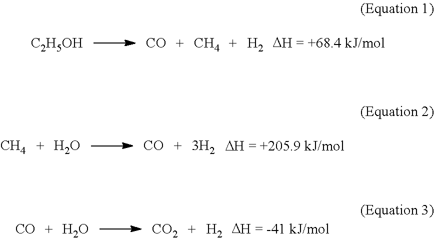

### Overall:

$$\begin{matrix}{C}_{2} {H}_{5} OH + 3 {H}_{2} O & 2 {CO}_{2} + 6 {H}_{2} & ΔH = + 172.7 kJ / mol\end{matrix} \qquad ( Equation 4 )$$

In another embodiment, ethanol is used as the fuel and the endothermic reforming reaction is as follows:

$$\begin{matrix}{C}_{2} {H}_{5} OH ( I ) + 3 {O}_{2} ( g ) \to 2 {CO}_{2} ( g ) + 3 {H}_{2} O ( I ) & ΔH = - 1368 kJ / mol\end{matrix} \qquad ( Equation 5 )$$

In another embodiment, part of the syngas gases is used as fuel in a continuous loop of successive reforming reactions such as follows:

$${H}_{2} + CO + {O}_{2} \to {H}_{2} O + {CO}_{2} + Heat \qquad ( Equation 6 )$$

In the illustrated embodiment, the input port 110a of each reactor conduit 110 is fluidly coupled to the wet fuel source 114. In some other embodiments, the input ports 110a of the reactor conduits 110 are collectively coupled to a single port of the wet fuel source 114 using a manifold-type element. In some other embodiments, the input ports of the reactor conduits are each fluidly coupled to a corresponding port of the wet fuel source, and the input ports may be operated independently from one another. Depending on the embodiment, the wet fuel source 114 can have a water source 114a and a fuel source 114b fluidly connected to the reactor conduits 110 via a first valve system 122. The first valve system 122 can have one or more valve elements actionable to individually or collectively control (e.g., initiate, modify) a flow or flows of wet fuel into one or more of the reactor conduits 110. In some embodiments, the first valve system 122 can be used to modify the fuel to water ratio of the wet fuel supplied to the reforming unit 100. In some embodiments, the first valve system 122 can have valve elements provided in the form of shutoff valve(s), stop valve(s), variable flow valve(s), ball valve(s), butterfly valve(s), gate valve(s), and the like. The first valve system 122 can be configured for providing the wet fuel with a water to fuel molar ratio ranging between about 15 and about 3, preferably between about 10 and about 5 and most preferably is of about 7.

In this embodiment, the heating devices 118 of the reforming unit 100 are collectively coupled to the ignition mixture source 120 having an air source 120a and to a fuel source 120b via a manifold-type element. Typically, the heating devices 118 are coupled to the air source 120a and to the fuel source 120 via a second valve system 124. The second valve system 124 can have one or more valve elements actionable to individually or collectively initiate a flow of air and a flow of fuel, or a mixture of air and fuel, into one or more of the heating devices 118. In some embodiments, the second valve system 124 can be used to modify the fuel to air ratio supplied to the heating devices 118 of the reforming unit 100. More specifically, the second valve system 124 is actionable to initiate and modify the flow of air, the flow of fuel and/or the flow of the mixture of air and fuel into the heating devices 118. In some embodiments, the second valve system 124 can have valve elements provided in the form of shutoff valve(s), stop valve(s), variable flow valve(s), ball valve(s), butterfly valve(s), gate valve(s), and the like. Ignition of the air and fuel supplied at the heating devices can be performed by one or more ignition modules, depending on the embodiment. The second valve system can be configured for providing the air and fuel with a fuel to air molar ratio ranging between about 20 and about 10, preferably between about 18 and about 12, and most preferably is about 16. In some embodiments, an axially oriented bottom burner 126 is provided a bottom end 102a of the catalytic burner 102, which is advantageous when the reforming unit 100 is vertically positioned, convection can carry the so-generated heat upwards towards the reaction assemblies. The bottom burner 126 can use a catalyst for heat generation by burning fuel injected from an inject point 130 and supplying the heat energy within the burner cavity 104. The bottom burner 126 can also be fluidly coupled to the ignition mixture source 120. The catalytic burner 102 can also have a fume port 131 where combustion fumes can exit the burner cavity 104 towards a fume conduit 132.

The wet fuel supplied to the reactor conduits 110 may be preheated in some embodiments, thereby reducing the heating requirements for the heating devices 118 and overall energy consumption, for instance. In some embodiments, the wet fuel can be preheated using one or more heat exchangers recycling heat fresh off the syngas or combustion fumes exiting the reaction assemblies 106 via the outputs 112b of the syngas conduits 112 or the fume port 131 of fume conduit 132.

In some embodiments, the syngas obtained using the reforming unit 100 can be used to obtain high purity hydrogen suitable for uses in different fields including, but not limited to, fuel cell use, internal combustion engine use (e.g., involving a dynamo, alternator, an electric power generator, a turbine), industrial use and the like. Purifying devices can be used downstream to purify the obtained syngas from the impurities it may contain including, but not limited to, carbon monoxide, and carbon dioxide.

As best shown in FIG. 1A, the catalytic burner 102 can have a circular cross-section 134. However, in other embodiments, catalytic burners can have cross-sections of any other suitable shape. FIG. 1B shows that the reaction assemblies 106 are circumferentially and radially spaced apart from one another in this example. Evenly distributed the reaction assemblies 106 within the burner cavity 104 can help evenly distribute the amount of heat that each reaction assembly 106 may receive from the heating devices 118.

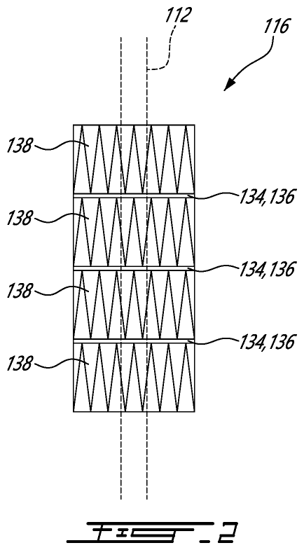

The catalyst elements can be provided in any suitable type of shape, form or be made of any suitable materials. For instance, the catalyst elements can be moulded, extruded, or folded metal support coated with reforming catalysts. The catalyst elements can even be provided in the form of solid pellets coated with the reforming catalysts in some other embodiments. In some embodiments, the catalyst elements 116 are provided in the form of annular metal discs 134 coated with reforming catalysts 136, an example of which is shown in FIG. 2. In some embodiments, the catalyst elements can be wholly or partially provided with metal oxide foam and/or silicon carbide foam. As depicted, the coated metal discs 134 may be annular in form to receive the syngas conduit 112 therein. The catalyst elements 116 can also have a folded metal mesh 138, a planar or folded sheet, a perforated sheet, or a combination thereof, coated with reforming catalysts 136 between the annular metal discs 134. The metal mesh 138 may be folded with certain patterns including, but not limited to, accordion, coil, spiral or combination thereof to enhance the surface area and heat transfer properties. However, other suitable shapes or forms for the catalyst elements can be provided. For instance, the catalyst elements can have any shape and be provided in any form increasing an area of contact between the reforming catalysts 136 and the wet fuel. For example, the catalysts elements may include a stack of coated metal mesh discs providing different catalyst zones, with each catalyst zones being packed with folded metal mesh or the above-described alternatives coated with reforming catalysts to enable gas phase reactants have sufficient interaction with catalyst and prevent gas phase reactants escape the reactor without contact with catalyst. The metal mesh disc or sheet can be shaped into fan, sieve, a distributor, or remixer into the catalyst zones. The coated catalyst may be made by standard method such as but not limited to sol gel, Physical Vapour Deposition (PVD), Chemical Vapour Deposition (CVD) or impregnation on a metal or any suitable surface and then heat-treated by calcination at up to 1000 degrees Celsius. The reforming catalysts can be substantially free of Cobalt (Co), Ruthenium (Ru), Rhodium (Rh), Palladium (Pd), Platinum (Pt), Iron (Fe), Molybdenum (Mb), and Boron (B). Examples of such reforming catalysts are described in Published PCT Application No. WO 2020/223793, the contents of which are hereby incorporated herein by reference.

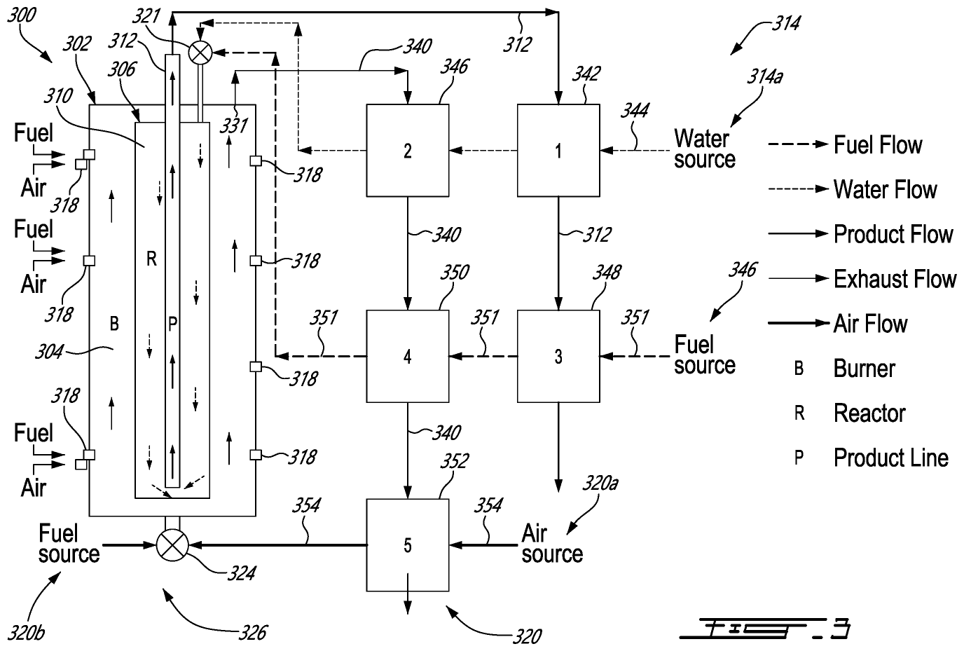

FIG. 3 shows another example of a reforming unit 300, in accordance with another embodiment. As shown, the reforming unit 300 has a catalytic burner 302 defining a burner cavity 304, and a single reaction assembly 306 lying within the burner cavity 304 and in thermal communication therewith. The single reaction assembly 306 is similar to the one described with reference to FIG. 1. Again, the catalytic burner 302 is provided with radially extending heating devices 318 which are fluidly coupled to the burner cavity 304 and a fume port 331 fluidly connecting the burner cavity 304 to a fume conduit 340 carrying combustion fumes resulting from the ignition and combustion away from the catalytic burner 302. In this embodiment, the reforming unit 300 is provided with heat exchangers external to the burner cavity 304 to heat the incoming wet fuel with already hot outgoing fluids such as the obtained syngas and combustion fumes, thereby limiting the heating requirements of the radially extending heating devices 318. More specifically, the reforming unit 300 has a water source 314a and a first fuel source 314b which are fluidly coupled to the reactor conduit 310 via a first valve system 321. The reforming unit 300 has an air source 320a and a second fuel source 320b which are fluidly coupled to the heating devices 318 via a second valve system 324. Although this embodiment shows that the first and second fuel sources 314b and 320b are shown separately from one another, in some other embodiments, the first and second fuel sources 314b and 320b may correspond to a single fuel source. A bottom or startup burner 326 can be provided at a bottom of the catalytic burner 302.

As shown, a first heat exchanging unit 342 is positioned downstream from the water source 314a and is in thermal exchange contact between a water conduit 344 and the syngas conduit 312 to heat the water incoming from the water source 314a with the syngas exiting the reforming unit 300. A second heat exchanging unit 346 is positioned downstream from the water source 314a and is in thermal exchange contact between a water conduit 344 and the fume conduit 340 to heat the water incoming from the water source 314a with the combustion fumes exiting the fume conduit 340. In this specific embodiment, the first and second heat exchanging units 342 and 346 are both provided along the same water conduit 344 so that one of the first and second heat exchanging units 342 and 346 heat water that has already been heated by the other one of the first and second heat exchanging units 342 and 346. More specifically, it was found preferable to position the first heat exchanging unit 342 upstream from the second heat exchanging unit 346 along the water conduit 344 for efficiency purposes. In this way, the first heat exchanger unit 342 can perform a first heat exchanging pass on the water to be followed with a second heat exchanging pass on the water by the second heat exchanging unit 346.

A third heat exchanging unit 348 is positioned downstream from the first fuel source 314b and is in thermal exchange contact between a fuel conduit 351 and the syngas conduit 312 to heat the fuel incoming from the first fuel source 314b with the syngas exiting the reforming unit 300. A third heat exchanging unit 350 is positioned downstream from the first fuel source 314b and is in thermal exchange contact between the fuel conduit 351 and the fume conduit 340 to heat the fuel incoming from the first fuel source 314b with the combustion fumes exiting the fume conduit 340. In this specific embodiment, the third and fourth heat exchanging units 348 and 350 are both provided along the same fuel conduit 351 so that one of the third and fourth heat exchanging units 348 and 350 heat fuel that has already been heated by the other one of the third and fourth heat exchanging units 348 and 350. It was found preferably to position the third heat exchanging unit 348 upstream from the fourth heat exchanging unit 350 along the fuel conduit for efficiency purposes. In this way, the third heat exchanger unit 348 can perform a first heat exchanging pass on the fuel to be followed with a second heat exchanging pass on the fuel by the fourth heat exchanging unit 350.

In some embodiments, the third heat exchanging unit 348 is downstream from the first heat exchanging unit 344 along the same syngas conduit 312 to use most of the heat carried by the syngas to heat the water first and then the fuel second. Similarly, the fourth heat exchanging unit 350 is downstream from the second heat exchanging unit 346 along the same fume conduit 340 to use most of the heat carried by the combustion fumes to heat the water first and then the fuel second. Proceeding accordingly may reduce the heating power requirements necessary to bring the water into steam, as required by the steam reforming reaction.

As shown, in some embodiments, a fifth heat exchanging unit 352 may be provided downstream from an ignition mixture source 320, e.g., an air source 320a and/or a fuel source 320b, and in thermal exchange contact between the fume conduit 340 and an air conduit 354 to heat the ignition mixture prior to ignition at the heating devices 318. Again, the fifth heat exchanging unit 352 may be downstream from the fourth heat exchanging unit 350 and along the same fume conduit 340 to favour upstream ones of the heat exchanging units, i.e., the second and fourth heat exchanging units 346 and 350.

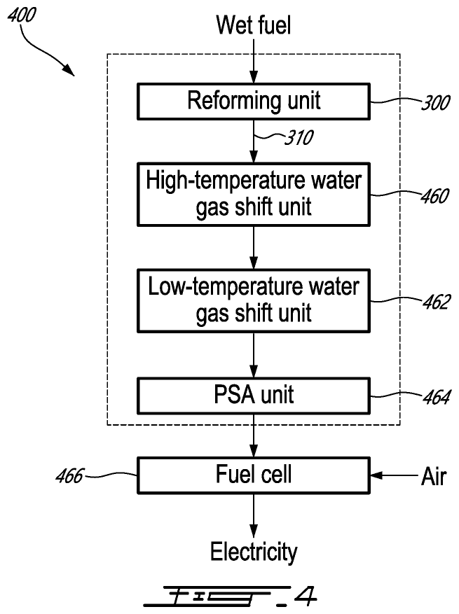

FIG. 4 shows an example of a power generation system 400 including the reforming unit 300 of FIG. 3, in accordance with an embodiment. As shown, the power generation system 400 has a fuel source fluidly connected to the reforming unit 300. The syngas conduit 310 is fluidly coupled to a high-temperature water gas shift unit 460 for converting the most of CO produced in the reforming unit 300 to H₂ and CO₂. A low-temperature was gas shift unit 462 is also provided downstream from the high-temperature water gas shift unit 460. The low-temperature water gas shift unit 462 is configured and adapted to converting the rest of CO after the high-temperature water gas shift unit 460 to H₂ and CO₂. Syngas gases upgrading may be achieved via the CO conversion into additional hydrogen in a single catalytic (water gas shift) reactor or a combination one or more catalytic steam shift reactors. Alternatively or additionally, remaining CO may be eliminated by using a selective CO oxidation into CO₂ or a methanation reaction. Then, a purifying device 464 such as a pressure swing adsorption (PSA) device or a filtering membrane is provided downstream from the low-temperature water gas shift unit 462 for removing impurities from the syngas to refine it into hydrogen. The hydrogen can be directed to a fuel cell or fuel cell stack 466 which when mixed used in conjunction with air can generate electrical power. More specifically, hydrogen from the reforming unit 300 and oxygen contained in the air can be consumed in electrochemical reactions occurring in the fuel cell 466 for generating electricity. The air can be supplied to the fuel cell using an air blower in some embodiments. It is envisaged that the power generation system can be used in an onboard device, a mobile device and/or a stationary device. It is noted that the reforming unit, the high-pressure temperature water gas shift unit 460 and the low-temperature water gas shift unit 462 operate at a pressure of up to 1000 psi or more, therefore the hydrogen containing syngas after low-temperature water gas shift unit 462 is also under pressure, which is ideal for the purifying device 464 to remove impurities from the hydrogen containing syngas to produce a pure hydrogen gas without necessarily requiring a compressor pressurizing the purifying device 464. Avoiding the use of a compressor makes the power generation system more cost-efficient and more feasible to be applied in the mobile devices. In some embodiments, the high-temperature water gas shift unit 460 and the low-temperature water gas shift unit 462 can be provided in the form of a reforming unit such as the one described at 300, but using another type of catalyst elements leading to an exothermic reaction instead of an endothermic reforming reaction. The number of reforming unit can differ from one embodiment to another. For instance, in some embodiments, there can be two or more reforming units arranged in series and/or in parallel within the power generation system 400. Moreover, the number of gas shift unit can differ from one embodiment to another. For instance, in the illustrated embodiment, two water gas shift units are used in series. However, in some other embodiments, a single water gas shift unit, or more than two water gas shift units, can also be used.

It is noted that the catalyst elements of the reforming unit 300, the high-temperature water gas shift unit 460 and the low-temperature water gas shift unit 464 may be coated with embedded catalyst components and additional metal oxide including, but not limited to, group I, group II and/or transition metals, and heat treated up to 1000 degrees Celsius to minimize the carbon formation and/or enhance protection against corrosive penetration action of H₂ and steam due to high temperature, therefore extending catalyst and processor life. Examples of such additional metal oxide can include, but is not limited to, potassium oxide (K₂O), oxocalcium (CaO), magnesium oxide (MgO), manganese dioxide (MnO₂) and/or chromium (III) oxide (Cr₂O₃). A start-up heating device may be used to provide heat at cold start of the reforming unit.

Depending on the embodiment, the heating devices can be ignition devices having a firing mechanism and being fluidly coupled to an ignition mixture source supplying a mixture of air and gas for ignition purposes. The heating devices can alternatively be provided in the form of electrical heaters, flame burners or catalytic burners using a fuel from external sources, tail gases or combination thereof from the purifying device or fuel cell as fuel to provide process heat. The burner catalyst can be a precious metal or transition metal oxide such as, but not limited to, platinum, palladium, rhodium, gold, silver, chromium oxide, cobalt oxide, nickel oxide, manganese oxide and deposited on a support such as, but not limited to, alumina, alumina fiber, fiberglass, ceramic fiber, any synthetic vitreous fiber, silicon carbide fibers, silicon nitride fibers, zirconia fibers, or Fiberfrax (R) ceramic fibers, foam, cordierite, mullite, porcelain, silicon nitride, zirconia, Steatite, wollastonite or any porous or non-porous ceramic.

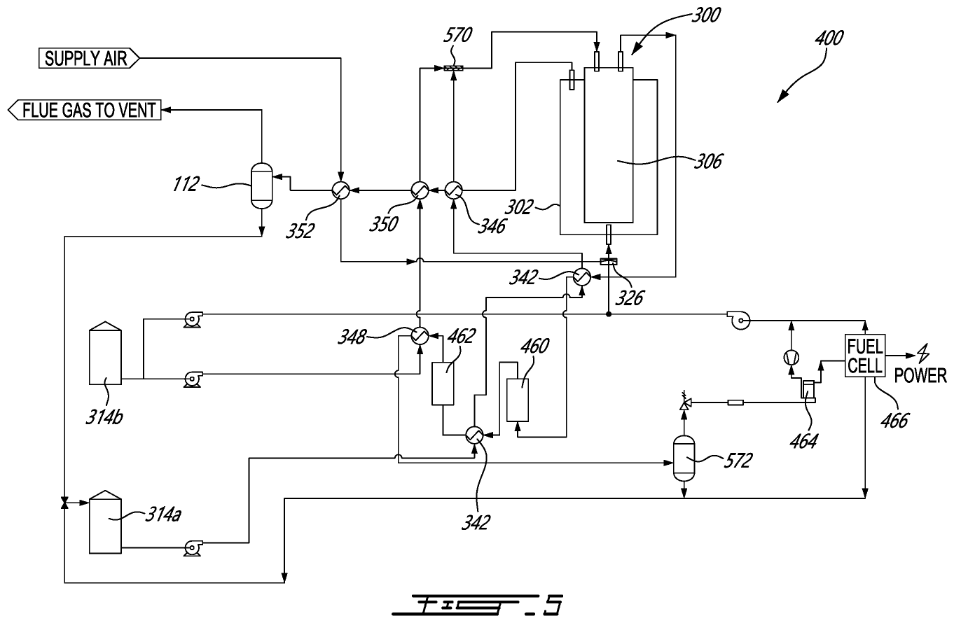

FIG. 5 shows detailed process diagram of the power generation system 400 of FIG. 4. As such there are shown the reforming unit 300, the purifying device 464, heat exchanging unit 342, 346, 348, 350 and 352 and fuel cell 466. During initial start-up of the system 400, supply air and ethanol from fuel source tank 314b were mixed and ignited in the start-up or bottom burner 326 which may be an electrical heater and/or a gas heater or, alternatively, air can be heated to 100-200° C. in electrical air heater before entering the catalytic burner 302 to preheat combustion catalyst to kick-off temperature. After catalytic combustion has started, start-up burner and/or electric air heater 326 can be turned off as ethanol/air mixture will react with combustion catalyst to generate heat. Hot exhaust gases or fumes are then used for initial preheating of feed in heat exchanging units 346, 350 and combustion air supply line in heat exchanging unit 352. After reformer reaction temperature has reached a given threshold, water from water tank 314a and ethanol from tank 314b are pumped into the cold side of heat exchangers 342, 346, 348, 350 and 352 in the way that latent heat from exhaust and/or syngas water can be collected by low boiling ethanol. These ensure maximum heat recovery of the process. Remaining heat from exhaust and syngas is utilized in heat exchanging unit 352 for combustion air heating. Ethanol vapour and steam are mixed in mixer 570 and enter the main reformer unit 300. In the reformer reactor assembly 306 ethanol/water mixture is converted into reformed gas including hydrogen, carbon dioxide, carbon monoxide and methane by steam reforming catalyst. The syngas is then passed through the hot side of heat exchanging units to recover the heat. The carbon monoxide in the syngas was converted into carbon dioxide and hydrogen in high temperature water gas shift (HTWGS) reactor 460 and low temperature water gas shift (LTWGS) reactor 462 consecutively. The excess heat from HTWGS 460 is removed by heat exchanging unit 342 before the syngas enters the reactor assembly 306. The unreacted water was separated in liquid/gas separator 572 and dried in the in-line adsorption dryer. Optionally, the syngas after water gas shift reactors 460 and 462 can be run through methanation reactor to convert remaining carbon monoxide into methane. After methanation process, carbon monoxide level can be at or below maximum concentration required for the fuel cell stack 466. In a next step, the syngas runs through the purifying device 464 yielding pure hydrogen and tail gas containing carbon dioxide, carbon monoxide, methane and some hydrogen. Pure hydrogen is used to generate electricity in the fuel cell stack 466. Tail gas from the purifying device 464 is collected and directed to the bottom burner 326 for main processes heat generation. At this point, ethanol supply for catalytic burner 302 is no longer required as combustion of tail gas combined with entire system heat recovery is self-sufficient to maintain reforming process running. The bottom burner 302 can then be turned off.

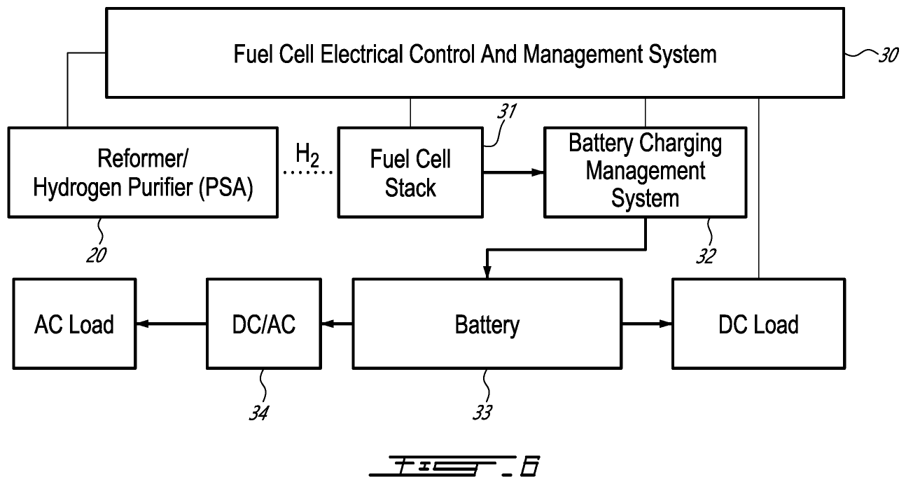

As shown in FIG. 6, a fuel cell electrical control and management system 30 provides the integration between the reforming unit 20, the fuel cell stack 31 and local electrical utility grid and/or power bank for off-grid operation. The reforming unit 20 provides the fuel cell stack 31 with hydrogen. The fuel cell stack 31 is connected to the battery bank 33 through charge controller 32. The state of the battery charge can vary with the power load. When the system power load is high the battery state of charge is low and when the system load is low the battery is charging to its high state of charge. The battery in this case provides energy during power load increase and allows reformer and/or fuel cell slowly rump up their performance. Similarly, during power load decrease, the battery will adsorb excess of energy and provide reformer and/or fuel cell to with time to ramp down. DC power loads can be connected directly to the battery or through DC/DC converter/inverter 34 if the voltage requirements are different from battery nominal voltage. AC load is connected to the battery via DC/AC inverter 34. Optionally, if/when the system is connected to the utility grid it will use the grid for start-up and load fluctuations management.

As can be understood, the examples described above and illustrated are intended to be exemplary only. For instance, the radially extending heating devices can be omitted in embodiments where heat exchanging units are provided, and vice versa. In some embodiments, there is described a reforming unit comprising: a catalytic burner defining a burner cavity; a reaction assembly within the burner cavity and in thermal communication therewith, the reaction assembly including: a reactor conduit extending annularly around an axis and axially between an input port and an output port, the input port being fluidly coupled to an input fuel source supplying input fuel, the reactor conduit having distributed therein a plurality of catalyst elements; and an output gas conduit extending along the axis, within the reactor conduit and in thermal communication therewith, the output gas conduit having an input port fluidly coupled to the output port of the reactor conduit, and an output port; the catalytic burner having a plurality of heating devices surrounding the burner cavity. In these embodiments, the reforming unit can be used for the production of hydrogen, for the production of synthetic or renewable natural gas, to name a few examples. In the latter embodiment, the reaction occurring within the reactor assembly would be an exothermic reaction instead of the endothermic reaction of the steam reforming process described herein.

While the disclosure has been described with particular reference to the illustrated embodiment, it will be understood that numerous modifications thereto will appear to those skilled in the art. Accordingly, the above description and accompanying drawings should be taken as illustrative and not in a limiting sense.

While the disclosure has been described in connection with specific embodiments thereof, it will be understood that it is capable of further modifications and this application is intended to cover any variations, uses, or adaptations and including such departures as come within known or customary practice within the art and as may be applied to the essential features hereinbefore set forth, and as follows in the scope of the appended claims.

1. A reforming unit for hydrogen production, the reforming unit comprising:
a catalytic burner defining a burner cavity;
a reaction assembly within the burner cavity and in thermal communication therewith, the reaction assembly including:
a reactor conduit extending annularly around an axis and axially between an input port and an output port, the input port being fluidly coupled to a wet fuel source supplying wet fuel, the reactor conduit having distributed therein a plurality of catalyst elements; and
a syngas conduit extending along the axis, within the reactor conduit and in thermal communication therewith, the syngas conduit having an input port fluidly coupled to the output port of the reactor conduit, and an output port;
the catalytic burner having a plurality of injection devices surrounding the burner cavity, wherein, upon activation, the injection devices inject an ignition mixture within the burner cavity, the ignition mixture reacting with catalyst contained within the burner cavity to generate heat, the heat heating the reactor conduit and the wet fuel thereby feeding, in cooperation with the plurality of catalyst elements, an endothermic reforming reaction producing a hydrogen containing syngas outputted at the output of the syngas conduit.

2. The reforming unit of claim 1 wherein at least two of the injection devices are axially spaced apart from one another.

3. The reforming unit of claim 1 wherein at least two of the injection devices are circumferentially spaced apart from one another around the catalytic burner.

4. The reforming unit of claim 1 wherein the reaction assembly is a first reaction assembly, the reforming unit further comprising a second reaction assembly laterally spaced apart from the first reaction assembly within the burner cavity.

5. The reforming unit of claim 4 wherein the input ports of the reactor conduits are coupled to the wet fuel source via a first valve system actionable to controllably receive a flow of wet fuel at the input ports of the reactor conduits.

6. The reforming unit of claim 1 wherein the injection devices are burner devices collectively coupled to an air source and to a fuel source via a second valve system actionable to controllably receive a flow of air and fuel for burning thereof.

7. The reforming unit of claim 1 wherein the wet fuel source has a water source and a fuel source fluidly coupled to the input port of the reactor conduit via the first valve system.

8. The reforming unit of claim 1 wherein the catalyst elements are provided in the form of a stack of annular metal discs coated with reforming catalysts, the annular metal discs receiving the syngas conduit therein.

9. The reforming unit of claim 8 wherein the reforming catalysts are substantially free of Cobalt (Co), Ruthenium (Ru), Rhodium (Rh), Palladium (Pd), Platinum (Pt), Iron (Fe), Molybdenum (Mo), and Boron (B).

10. The reforming unit of claim 1 wherein the catalytic burner has a fume port fluidly connected to a fume conduit carrying fumes away from the catalytic burner.

11. The reforming unit of claim 10 further comprising a heat exchanging unit being in thermal exchange contact between the fume conduit and a fuel conduit incoming from the wet fuel source.

12. The reforming unit of claim 1 further comprising a heat exchanger unit being in thermal exchange contact between the syngas conduit and a fuel conduit incoming from the wet fuel source.

13. The reforming unit of claim 1 further comprising a first heat exchanging unit positioned downstream from a water source and in thermal exchange contact between a water conduit fluidly coupled to the water source and the syngas conduit to heat the water incoming from the water source with the syngas exiting the reforming unit.

14. The reforming unit of claim 13 further comprising a second heat exchanging unit positioned downstream from the water source and in thermal exchange contact between a water conduit fluidly coupled to the water source and a fume conduit to heat the water incoming from the water source with fumes exiting the fume conduit.

15. The reforming unit of claim 14 wherein the first and second heat exchanging units are provided along the same water conduit, with the second heat exchanging unit being downstream from the first heat exchanging unit.

16. The reforming unit of claim 1 further comprising a first heat exchanging unit positioned downstream from a first fuel source and in thermal exchange contact between a first fuel conduit fluidly coupled to the first fuel source and the syngas conduit to heat fuel incoming from the first fuel source with the syngas exiting the reforming unit.

17. The reforming unit of claim 16 further comprising a second heat exchanging unit positioned downstream from the first fuel source and in thermal exchange contact between a fuel conduit fluidly coupled to the first fuel source and the fume conduit to heat the fuel incoming from the first fuel source with the fumes exiting the fume conduit.

18. The reforming unit of claim 17 wherein the first and second heat exchanging units are provided along the same fuel conduit, with the second heat exchanging unit being downstream from the first heat exchanging unit.

19. The reforming unit of claim 1 wherein the wet fuel is wet ethanol.

20. A power generation device comprising: the reforming unit of any one of claims 1 to 19, at least a water gas shift unit receiving the hydrogen containing syngas from the reforming unit and converting carbon monoxide present in the hydrogen containing syngas into hydrogen and carbon dioxide, and a purifying device receiving the hydrogen containing syngas from the water gas shift unit, removing impurities therefrom, and outputting a hydrogen gas stream.

21. The power generation device of claim 20 further comprising a fuel cell receiving the hydrogen gas stream from the purifying device and an air stream, and generating electricity.

22-31. (canceled)

32. A reforming unit comprising:
a catalytic burner defining a burner cavity;
a reaction assembly within the burner cavity and in thermal communication therewith, the reaction assembly including:
a reactor conduit extending annularly around an axis and axially between an input port and an output port, the input port being fluidly coupled to an input fuel source supplying input fuel, the reactor conduit having distributed therein a plurality of catalyst elements; and
an output gas conduit extending along the axis, within the reactor conduit and in thermal communication therewith, the output gas conduit having an input port fluidly coupled to the output port of the reactor conduit, and an output port;
the catalytic burner having a plurality of ignition mixture injection devices surrounding the burner cavity and distributed around the axis.
